(19) United States
(12) Patent Application Publication
(10) Pub. No.: US 2022/0083375 A1
(43) Pub. Date: Mar. 17, 2022

(54) METHOD AND APPARATUS FOR SCHEDULING TASK PROCESSING ENTITY

(71) Applicant: HUAWEI TECHNOLOGIES CO., LTD., Shenzhen (CN)

(72) Inventor: Yan ZENG, Shenzhen (CN)

(21) Appl. No.: 17/538,617

(22) Filed: Nov. 30, 2021

Related U.S. Application Data
(63) Continuation of application No. PCT/CN2020/092718, filed on May 27, 2020.

(30) Foreign Application Priority Data
May 30, 2019 (CN) 201910465639.X

(51) Int. Cl. G06F 9/48; G06F 9/50

(52) U.S. Cl. CPC G06F 9/4881; G06F 2209/503; G06F 2209/505; G06F 9/5038

(57) ABSTRACT

This application discloses example methods for scheduling a task processing entity. One example method includes receiving, by a first task processing entity, resource requirement information associated with a to-be-processed task. The first task processing entity can then determine m second task processing entities based on an entity status information table and the resource requirement information, where a status that is of each of the m second task processing entities and that is recorded in the entity status information table is an idle state. The first task processing entity can then identify from the m second task processing entities, a particular second task processing entity that currently includes an idle resource meeting the resource requirement information. The first task processing entity can then schedule the particular second task processing entity to process the to-be-processed task.

### CROSS-REFERENCE TO RELATED APPLICATIONS

This application is a continuation of International Application No. PCT/CN2020/092718, filed on May 27, 2020, which claims priority to Chinese Patent Application No. 201910465639.X, filed on May 30, 2019. The disclosures of the aforementioned applications are hereby incorporated by reference in their entireties.

### TECHNICAL FIELD

This application relates to the communications field, and in particular, to a method and an apparatus for scheduling a task processing entity.

### BACKGROUND

In a scenario oriented for perception of everything and internet of everything, edge computing is becoming a trend, and edge computing has been gradually applied to industries such as internet of things, big data, and artificial intelligence. In edge computing, data is processed by using a cluster near a data source, and edge computing is closer to a user. A cluster at an edge implements data filtering and analysis, and features a good effect and a low delay.

The cluster at the edge includes a cluster list, and the cluster list includes an identifier of at least one other cluster. When the cluster receives a task used to process data, if an idle resource of the cluster cannot meet a resource required for processing the task, a cluster is randomly selected from clusters corresponding to identifiers of the clusters included in the cluster list; whether an idle resource in the selected cluster meets the resource required for processing the task is queried; and if the idle resource in the selected cluster meets the resource required for processing the task, the selected cluster is scheduled to process the task; or if the idle resource in the selected cluster does not meet the resource required for processing the task, an identifier of a cluster is reselected from the cluster list, and then the selected cluster is found based on the foregoing steps.

In a process of implementing this application, the inventors find that a conventional technology has at least the following problems:

In some cases, selection may need to be performed a plurality of times to find a cluster that meets the resource required by the task. Consequently, time required for querying the cluster is long, and a delay required for successfully scheduling the cluster is high.

### SUMMARY

Embodiments of this application provide a method and an apparatus for scheduling a task processing entity, to improve efficiency of scheduling the task processing entity. Technical solutions are as follows.

According to one aspect, this application provides a method for scheduling a task processing entity. In the method, a first task processing entity receives a task processing request message, where the task processing request message carries resource requirement information required by a to-be-processed task, the resource requirement information includes at least a quantity of required resources and a resource type that are required for processing the to-be-processed task, and the first task processing entity is a cluster or a device; when an idle resource included in the first task processing entity does not meet the resource requirement information, the first task processing entity determines m second task processing entities based on an entity status information table and the resource requirement information, where the entity status information table includes entity information sent by at least one second task processing entity and received by the first task processing entity, the entity information sent by the second task processing entity includes an identifier, a status, and idle resource information that are of the second task processing entity, the idle resource information includes at least a resource type of an idle resource in the second task processing entity and a quantity of idle resources, a status that is of each of the m second task processing entities and that is recorded in the entity status information table is an idle state, a quantity of idle resources corresponding to the resource type that are in each second task processing entity is greater than the quantity of required resources, and m is an integer greater than or equal to 1; and the first task processing entity queries, from the m second task processing entities, a second task processing entity that currently includes an idle resource meeting the resource requirement information, and schedules the found second task processing entity to process the to-be-processed task. Because the status of each of the m second task processing entities is the idle state and idle resource information of each second task processing entity meets the resource requirement information, a query range can be narrowed down, and a probability of finding a second task processing entity whose idle resource meets the resource requirement information increases. This can improve query efficiency and scheduling efficiency.

In a possible implementation, the first task processing entity obtains entity information of the first task processing entity, and sends the entity information to each task processing entity in an entity list, where the entity list includes an identifier of at least one task processing entity other than the first task processing entity. This helps another task processing entity create the entity status information table based on the entity information of the first task processing entity.

In a possible implementation, the first task processing entity obtains each resource type included in the first task processing entity and a quantity of idle resources and a total quantity of resources corresponding to each resource type; and the first task processing entity determines a status of the first task processing entity based on the quantity of idle resources and the total quantity of resources corresponding to each resource type.

In a possible implementation, a quantity of idle resources and a total quantity of resources corresponding to each resource type included in each node in the cluster are obtained; a status of each node is determined based on each resource type included in each node and the quantity of idle resources and the total quantity of resources corresponding to each resource type; and a status of the cluster is determined based on the status of each node.

In a possible implementation, resource usage corresponding to each resource type in the node is obtained based on the quantity of idle resources and the total quantity of resources corresponding to each resource type included in the node; and when maximum resource usage in the resource usage corresponding to each resource type is greater than or equal to a preset usage threshold, it is determined that the node is in a busy state; or when the maximum resource usage is less than the preset usage threshold, it is determined that the node is in the idle state.

In a possible implementation, a quantity of nodes in the busy state and a total quantity of nodes in the cluster are obtained; a ratio of the nodes in the busy state and a quantity of nodes in the idle state are obtained based on the quantity of nodes in the busy state and the total quantity of nodes; and when the ratio is greater than or equal to a preset ratio threshold and the quantity of nodes in the idle state is less than a preset quantity threshold, it is determined that the cluster is in the busy state; or when the ratio is greater than or equal to the preset ratio threshold and the quantity of nodes in the idle state is greater than or equal to the preset quantity threshold, or when the ratio is less than the preset ratio threshold, it is determined that the cluster is in the idle state.

In a possible implementation, the first task processing entity sends a query request message to each of the m second task processing entities, where the query request message carries the resource requirement information, and the query request message is used by the second task processing entity to query whether an idle resource included in the second task processing entity meets the resource requirement information; receives a query result sent by each second task processing entity; selects a query result that is received for the first time and that indicates that an idle resource meets the resource requirement information; and schedules a second task processing entity that sends the selected query result to process the to-be-processed task. Because query request messages are concurrently sent to the m second task processing entities, and the query result that is received for the first time and that indicates that an idle resource meets the resource requirement information is selected, it is not necessary to wait until query results sent by all second task processing entities are received. This can further improve scheduling efficiency.

In a possible implementation, the first task processing entity receives entity information of at least one second task processing entity; the first task processing entity obtains entity information of n second task processing entities in the idle state from the entity information of the at least one second task processing entity, where n is an integer greater than or equal to 1; the first task processing entity determines, based on entity information of each of the n second task processing entities by using a prediction model, a second task processing entity whose state is to change to the busy state; and the first task processing entity removes, from the entity information of the n second task processing entities, entity information of the second task processing entity that is to change to the busy state, and forms the entity status information table by using entity information of a remaining second task processing entity. Because the entity information of the second task processing entity that is to change to the busy state is removed, a probability of determining the m second task processing entities based on the entity status information table, querying the m second task processing entities, and finding the second task processing entity whose idle resource meets the resource requirement information is significantly improved.

According to another aspect, this application provides an apparatus for scheduling a task processing entity, configured to perform the method in any one of the first aspect or the optional implementations of the first aspect. Specifically, the apparatus includes units configured to perform the method in the first aspect or any one of the possible implementations of the first aspect.

According to another aspect, this application provides an apparatus for scheduling a task processing entity. The apparatus includes at least one processor, at least one memory, and at least one transceiver. The at least one processor is connected to the at least one memory and the at least one transceiver by using a bus. The at least one memory stores one or more programs, the one or more programs are configured to be executed by the at least one processor, and the one or more programs include instructions used to perform the method according to the first aspect or any one of the possible implementations of the first aspect.

According to another aspect, this application provides a computer-readable storage medium. The computer-readable storage medium stores instructions. When the instructions are run on a computer, the computer is enabled to perform the method according to the first aspect or any one of the possible implementations of the first aspect.

According to another aspect, this application provides a computer program product including instructions. When the computer program product runs on a computer, the computer is enabled to perform the method according to the first aspect or any one of the possible implementations of the first aspect.

### BRIEF DESCRIPTION OF DRAWINGS

FIG. 1 is a schematic diagram of a network architecture according to an embodiment of this application;

FIG. 2 is a schematic diagram of another network architecture according to an embodiment of this application;

FIG. 3 is a schematic diagram of another network architecture according to an embodiment of this application;

FIG. 4 is a flowchart of a method for obtaining a cluster state information table according to an embodiment of this application;

FIG. 5 is a flowchart of a method for scheduling a cluster according to an embodiment of this application;

FIG. 6 is a flowchart of a method for obtaining a device status information table according to an embodiment of this application;

FIG. 7 is a flowchart of a method for scheduling a device according to an embodiment of this application;

FIG. 8 is a schematic diagram of a structure of an apparatus for scheduling a task processing entity according to an embodiment of this application; and

FIG. 9 is a schematic diagram of a structure of another apparatus for scheduling a task processing entity according to an embodiment of this application.

### DESCRIPTION OF EMBODIMENTS

The following further describes in detail the implementations of this application with reference to accompanying drawings.

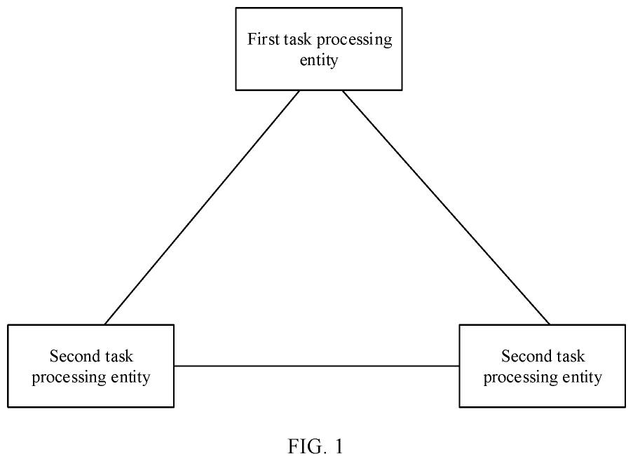

Refer to FIG. 1. An embodiment of this application provides a network architecture. The network architecture is a distributed network architecture including a plurality of task processing entities. The plurality of task processing entities are distributed in a same local area network, or the plurality of task processing entities are distributed in different local area networks. The plurality of task processing entities are connected by using a network.

For any task processing entity, for ease of description, the task processing entity is referred to as a first task processing entity. The first task processing entity may receive entity information sent by at least one second task processing entity. The entity information sent by the second task processing entity includes an identifier, a status, and idle resource information that are of the second task processing entity, and the idle resource information includes at least a resource type of each idle resource in the second task processing entity and a quantity of idle resources. An entity status information table is generated based on the entity information sent by the at least one second task processing entity, and the entity status information table is used to store entity information of a second task processing entity in an idle state.

In this way, the first task processing entity may receive a task processing request message. The task processing request message carries resource requirement information required by a to-be-processed task, and the resource requirement information includes a quantity of required resources and a resource type that are required by the to-be-processed task. When an idle resource included in the first task processing entity does not meet the resource requirement information, the first task processing entity determines m second task processing entities based on the entity status information table and the resource requirement information. A status of each of the m second task processing entities is the idle state, a quantity of idle resources corresponding to the resource type that are in each second task processing entity is greater than the quantity of required resources, and m is an integer greater than or equal to 1.

The first task processing entity queries, from the m second task processing entities, a second task processing entity that includes an idle resource meeting the resource requirement information, and schedules the found second task processing entity to process the to-be-processed task.

That the idle resource included in the first task processing entity meets the resource requirement information means that a quantity of idle resources corresponding to the resource type that are in the first task processing entity is greater than the quantity of required resources. That the idle resource included in the first task processing entity does not meet the resource requirement information means that the quantity of idle resources corresponding to the resource type that are in the first task processing entity is less than or equal to the quantity of required resources.

The task processing entity may be a cluster or a device, the cluster may be an edge cluster, and the device may be an edge device or an end-side device.

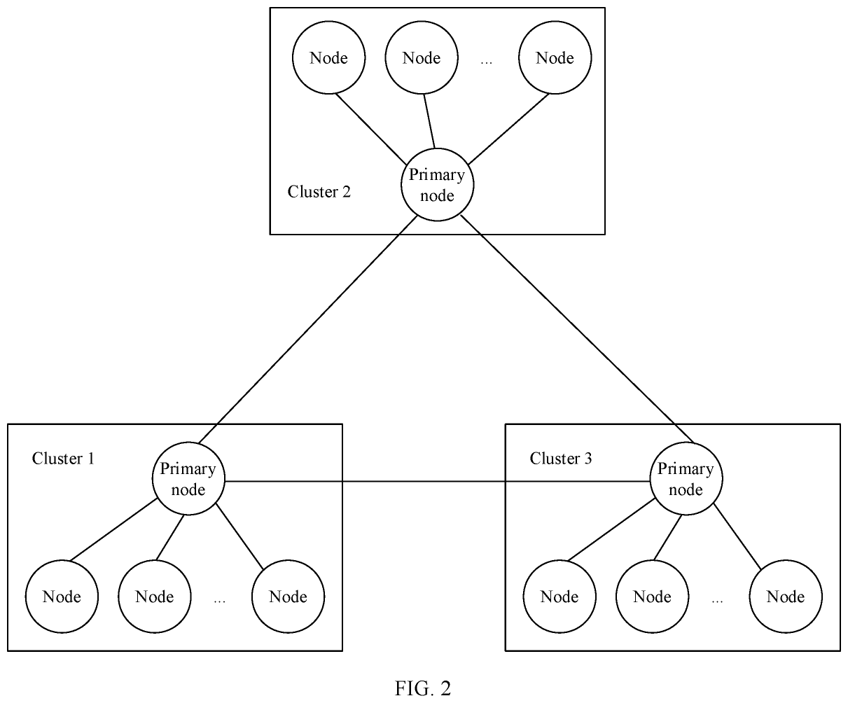

When the task processing entity is a cluster, as shown in FIG. 2, the network architecture includes a plurality of clusters, and a network connection is established between any two clusters in the plurality of clusters.

For any cluster in the plurality of clusters, for ease of description, the cluster is referred to as a first cluster, the first cluster includes at least one node, and there is one primary node in the at least one node. For ease of description, the primary node is referred to as a first primary node, and a network connection may be established between the first primary node and each of other nodes.

The first primary node is configured to manage the at least one node included in the first cluster. For example, the first primary node may receive a task processing request message from a terminal, select a node from the at least one node, and trigger the selected node to process a task corresponding to the task processing request message.

Optionally, the first primary node may obtain a quantity of idle resources and a total quantity of resources corresponding to each resource type currently included in each node in the first cluster.

When any node in the first cluster is powered on and started, the first primary node may obtain a quantity of idle resources and a total quantity of resources corresponding to each resource type included in the node, and store the quantity of idle resources and the total quantity of resources corresponding to each resource type included in the node. Then, the first primary node may periodically or aperiodically query a quantity of idle resources corresponding to each resource type currently included in the node, and separately update the stored quantity of idle resources corresponding to each resource type in the node to the currently found quantity of idle resources corresponding to each resource type. Alternatively, when an idle resource corresponding to a specific resource type included in the node changes, the node sends the resource type and a quantity of current idle resources to the first primary node, and the first primary node receives the resource type and the quantity of current idle resources, and updates a stored quantity of idle resources corresponding to the resource type in the node to the received quantity of current idle resources.

In this way, the first primary node receives a task processing request message, where the task processing request message carries resource requirement information required by a to-be-processed task, and the resource requirement information includes at least a resource type, a quantity of required resources, and the like; determines, based on the quantity of required resources and a quantity of idle resources corresponding to the resource type currently included in each node, whether there is a target node in the first cluster, where the target node is a node that is included in the first cluster and on which an idle resource corresponding to the resource type meets the resource requirement information; and if there is the target node, selects a node from the target node, and triggers the selected node to process a task corresponding to the task processing request message.

If there is no target node, the first primary node may query another cluster including an idle resource that is corresponding to the resource type and that meets the resource requirement information, and forward the task processing request message to the another cluster, and the another cluster processes the task corresponding to the task processing request message.

The first primary node may determine m second clusters based on a cluster state information table and the resource requirement information, where the cluster state information table includes cluster information of at least one second cluster other than the first cluster, the cluster information of the second cluster includes an identifier of the second cluster, a status of the second cluster, and a quantity of idle resources corresponding to each resource type included in a node in the second cluster, states that are of the m second clusters and that are recorded in the cluster state information table each are an idle state, a quantity of idle resources corresponding to the resource type that are included in each of the m second clusters is greater than the quantity of required resources, and m is an integer greater than or equal to 1; and the first primary node queries whether an idle resource currently actually included in each of the m second clusters meets the resource requirement information, and when a second cluster that meets the resource requirement information is found, schedules the found second cluster to process the to-be-processed task.

Because the quantity, recorded in the cluster state information table, of idle resources corresponding to the resource type that are included in each of the m second clusters is greater than the quantity of required resources, and the states of the m second clusters each are the idle state, a query range can be narrowed down, and a probability that a quantity of idle resources corresponding to the resource type that are currently actually included in each of the m second clusters is greater than the quantity of required resources is large. Therefore, a second cluster whose current actual idle resource meets the resource requirement information can be quickly found during query of the m second clusters. This can improve query efficiency and scheduling efficiency.

The first primary node may obtain cluster information of the first cluster, and broadcast the cluster information of the first cluster to another cluster. Optionally, the first primary node may obtain and broadcast the cluster information of the first cluster periodically, randomly, or when being triggered by an event.

The cluster information of the first cluster includes an identifier and a status that are of the first cluster and a quantity of idle resources corresponding to each resource type included in the node in the first cluster. The first primary node may obtain the cluster information of the first cluster in the following manner:

The first primary node obtains the identifier of the first cluster that is stored in the first primary node, and obtains a quantity of idle resources and a total quantity of resources corresponding to each resource type currently included in each node in the first cluster; determines a status of each node based on the quantity of idle resources and the total quantity of resources corresponding to each resource type included in each node; and determines a status of the first cluster based on the status of each node, to obtain the cluster information of the first cluster.

For ease of description, each node is referred to as a target node. The first primary node may determine a status of the target node in the following manner:

The first primary node may obtain resource usage corresponding to each resource type in the target node based on a quantity of idle resources and a total quantity of resources corresponding to each resource type included in the target node; and when maximum resource usage in the resource usage corresponding to each resource type is greater than or equal to a preset usage threshold, the first primary node determines that the status of the target node is the busy state; or when the maximum resource usage in the resource usage corresponding to each resource type is less than the preset usage threshold, the first primary node determines that the status of the target node is the idle state.

The first primary node may determine the status of the first cluster in the following manner:

The first primary node obtains a quantity of nodes in the busy state that are included in the first cluster and a total quantity of nodes included in the first cluster; the first primary node obtains a ratio of the nodes in the busy state and a quantity of nodes in the idle state based on the quantity of nodes in the busy state and the total quantity of nodes; and when the ratio is greater than or equal to a preset ratio threshold and the quantity of nodes in the idle state is less than a preset quantity threshold, the first primary node determines that the status of the first cluster is the busy state; or when the ratio is greater than or equal to the preset ratio threshold and the quantity of nodes in the idle state is greater than or equal to the preset quantity threshold, or when the ratio is less than the preset ratio threshold, the first primary node determines that the status of the first cluster is the idle state.

Optionally, the first primary node may include a cluster resource pool. The cluster resource pool includes an identifier of at least one second cluster other than the first cluster. The first primary node may broadcast, to each second cluster based on an identifier that is of each second cluster and that is included in the cluster resource pool, cluster information obtained by the first primary node.

A primary node in each cluster in the network architecture broadcasts, in the foregoing manner, cluster information of the cluster in which the primary node is located. In this way, the first primary node may obtain a cluster state information table on the first primary node in the following manner:

The first primary node receives cluster information of the at least one second cluster other than the first cluster, where the cluster information of the second cluster includes an identifier and a status that are of the second cluster and a quantity of idle resources corresponding to each resource type included in a node in the second cluster; the first primary node obtains cluster information of n second clusters in the idle state from the cluster information of the at least one second cluster, where n is an integer greater than or equal to m; the first primary node determines, based on cluster information of each of the n second clusters by using a prediction model, a second cluster whose state is to change to the busy state; and the first primary node removes, from the cluster information of the n second clusters, cluster information of the second cluster that is to change to the busy state, and forms the cluster state information table by using cluster information of a remaining second cluster.

Optionally, the prediction model may be a machine learning algorithm, a convolutional neural network, or the like that is trained in advance. A plurality of pieces of first sample data may be preset in advance. Each piece of first sample data is cluster information of one cluster, and cluster is in the idle state. A skilled person analyzes the cluster information of the cluster to determine whether the cluster is to change to the busy state, and saves an analysis result to the first sample data to obtain second sample data. The machine learning algorithm or the convolutional neural network is trained by using the obtained second sample data to obtain the prediction model.

The first primary node may input the cluster information of the n second clusters to the prediction model. For cluster information of any second cluster, the prediction model predicts, based on a quantity that is of idle resources corresponding to each resource type in the node and that is included in the cluster information of the second cluster, whether status of the second cluster is to change to the busy state. The first primary node obtains a prediction result that is output by the prediction model and that is obtained by predicting the second cluster, and if the prediction result is that the status of the second cluster is to change to the busy state, the first primary node discards the cluster information of the second cluster; or otherwise, the first primary node adds the cluster information of the second cluster to the cluster state information table.

Each cluster in the network architecture may broadcast cluster information of the cluster periodically, randomly, or when being triggered by an event.

Therefore, the first primary node may continuously receive cluster information sent by different second clusters, and periodically or aperiodically create the cluster state information table based on the received cluster information.

Optionally, the first primary node may alternatively replace a previously created cluster state information table with the currently formed cluster state information table.

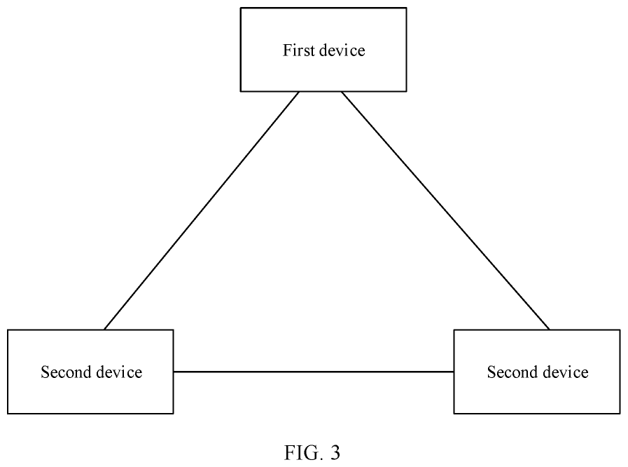

When the task processing entity is a device, as shown in FIG. 3, the network architecture includes a plurality of devices, and a network connection is established between any two devices in the plurality of devices.

For ease of description, any device in the plurality of devices is referred to as a first device. The first device may receive a task processing request message, where the task processing request message carries resource requirement information required by a to-be-processed task, and the resource requirement information includes a resource type, a quantity of required resources, and the like that are required by the to-be-processed task. When an idle resource included in the first device meets the resource requirement information, the first device processes a task corresponding to the task processing request message. When the idle resource included in the first device does not meet the resource requirement information, the first device may query a second device that includes an idle resource meeting the resource requirement information, and schedule the found second device to process the to-be-processed task.

The first device may determine m second devices based on a device status information table and the resource requirement information, where the device status information table includes device information of at least one second device other than the first device, the device information of the second device includes an identifier of the second device, a status of the second device, a resource type corresponding to each type of idle resource included in the second device, and a quantity of idle resources, states that are of the m second devices and that are recorded in the device status information table each are an idle state, quantities of idle resources corresponding to the resource type that are in the m second devices are greater than the quantity of required resources, and m is an integer greater than or equal to 1; and the first device queries whether an idle resource currently actually included in each of the m second devices meets the resource requirement information, and when a second device that meets the resource requirement information is found, schedules the found second device to process the to-be-processed task.

Because quantities, recorded in the device status information table, of idle resources corresponding to the resource type that are in the m second devices are greater than the quantity of required resources, and the states of the m second devices each are the idle state, a query range can be narrowed down, and a probability that a quantity of idle resources of the resource type that are currently actually included in each of the m second devices is greater than the quantity of required resources is large. Therefore, a second device whose current actual idle resource meets the resource requirement information can be quickly found during query of the m second devices. This can improve query efficiency and scheduling efficiency.

The first device may obtain device information of the first device, and broadcast the device information to another device. Optionally, the first device may obtain and broadcast the device information of the first device periodically, randomly, or when being triggered by an event.

The device information of the first device includes an identifier and a status that are of the first device and a quantity of idle resources corresponding to each resource type included in the first device.

Optionally, the first device may include a device list. The device list includes an identifier of at least one other device other than the first device. The first device may broadcast, to each device based on an identifier that is of each device and that is included in the device list, device information obtained by the first device.

Each device in the network architecture broadcasts respective device information in the foregoing manner. In this way, for a device status information table on the first device, the first device may obtain the device status information table in the following manner:

The first device receives device information of at least one second device other than the first device, where the device information of the second device includes an identifier and a status that are of the second device, a resource type of each type of idle resource included in the second device, and a quantity of idle resources; obtains device information of n second devices in the idle state from the device information of the at least one second device, where n is an integer greater than or equal to m; determines, based on device information of each of the n second devices by using a prediction model, a second device whose state is to change to the busy state; and removes, from the device information of the n second devices, device information of the second device that is to change to the busy state, and forms the device status information table by using device information of a remaining second device.

The first device may input the device information of the n second devices to the prediction model. For each second device, the prediction model predicts, based on a quantity that is of idle resources corresponding to each resource type and that is included in device information of the second device, whether a status of the second device is to change to the busy state. The first device obtains a prediction result that is output by the prediction model and that is obtained by predicting the second device, and if the prediction result is that the status of the second device is to change to the busy state, the first device discards the device information of the second device; or otherwise, the first device adds the device information of the second device to the device status information table.

A plurality of pieces of first sample data may be preset in advance. Each piece of first sample data is device information of a device, and a status of the device is the idle state. A skilled person analyzes the device information of the device to determine whether the device is to change to the busy state, and saves an analysis result to the first sample data to obtain second sample data. The machine learning algorithm or the convolutional neural network is trained by using the obtained second sample data to obtain the prediction model.

Each device of at least one device other than the first device may broadcast device information of the device periodically, randomly, or when being triggered by an event.

The first device may receive device information of the at least one device each time, and form the device status information table in the foregoing manner based on the device information received each time.

Optionally, the first device may alternatively replace a previously created device status information table with the currently formed device status information table.

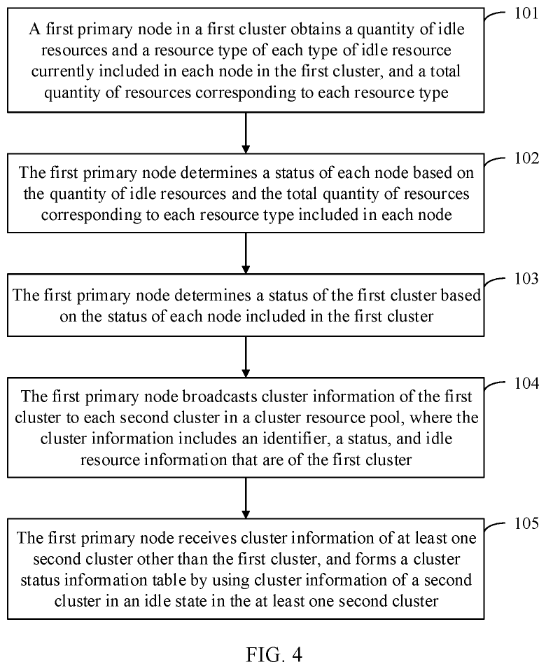

In the network architecture shown in FIG. 1 or FIG. 2, a primary node in a cluster needs to obtain and store a cluster state information table, so that it can be ensured that only when an idle resource included in the cluster in which the primary node is located cannot meet resource requirement information required for processing a task, can the primary node efficiently query, based on the cluster state information table, another cluster whose idle resource meets the resource requirement information, and schedule the found cluster to process the to-be-processed task. Refer to FIG. 4. This application provides a method for obtaining a cluster state information table. The method may be applied to the network architecture shown in FIG. 1 or FIG. 2. The method includes the following steps.

Step 101: A first primary node in a first cluster obtains a quantity of idle resources and a resource type of each type of idle resource currently included in each node in the first cluster, and a total quantity of resources corresponding to each resource type.

The first cluster is any cluster in the network architecture.

Optionally, the resource type included in the node may be a central processing unit (central processing unit, CPU), a graphics processing unit (graphics processing unit, GPU), a memory, and/or the like. The quantity of each type of idle resource currently included in the node and the total quantity of resources may be a quantity of idle CPUs currently included in the node and a total quantity of CPUs, a quantity of idle GPUs and a total quantity of GPUs, a size of an idle memory and a total memory size, and/or the like.

A primary node in any cluster in the network architecture shown in FIG. 1 or FIG. 2 performs this step periodically, randomly, or when being triggered by an event.

In this step, the following two implementations are listed. Other implementations are not listed one by one in this step. The two implementations are separately described as follows:

In a first implementation, the first primary node may query a quantity of idle resources corresponding to each resource type currently included in each node in the first cluster, and obtain a total quantity of resources corresponding to each resource type included in each node.

In the first implementation, when determining to obtain cluster information of the first cluster, the first primary node may send a query request message to each node in the first cluster. When any node in the first cluster receives the query request message, the node obtains a quantity of idle resources corresponding to each resource type currently included in the node, and sends a query response message to the first primary node. The query response message includes each resource type and the quantity of idle resources corresponding to each resource type.

Optionally, the node may alternatively obtain a total quantity of resources corresponding to each resource type that are included in the node, and a query response message sent to the primary node may also include the total quantity of resources corresponding to each resource type.

The first primary node receives the query response message, and extracts, from the query response message, each resource type currently included in the node and the total quantity of idle resources corresponding to each resource type.

Optionally, when the query response message further includes the total quantity of resources corresponding to each resource type in the node, the first primary node extracts the total quantity of resources corresponding to each resource type in the node from the query response message.

Optionally, when the query response message does not include the total quantity of resources corresponding to each resource type in the node, the first primary node may obtain, based on an identifier of the node from a correspondence among an identifier, a resource type, and a total quantity of resources, the total quantity of resources corresponding to each resource type included in the node.

Optionally, during creation of the first cluster, each resource type included in the node in the first cluster and the total quantity of resources corresponding to each resource type may be manually entered to the first primary node, or the first primary node queries each resource type included in the node in the first cluster and the total quantity of resources corresponding to each resource type, or the node in the first cluster actively sends, to the first primary node, each resource type included in the node and the total quantity of resources corresponding to each resource type. When obtaining each resource type included in the node and the total quantity of resources corresponding to each resource type, the first primary node may correspondingly store the identifier of the node, each resource type included in the node, and the total quantity of resources corresponding to each resource type in the correspondence among an identifier, a resource type, and a total quantity of resources.

Optionally, when a node is added to the first cluster, each resource type included in the node and a total quantity of resources corresponding to each resource type may be manually entered to the first primary node, or the first primary node queries each resource type included in the node and a total quantity of resources corresponding to each resource type, or the node sends, to the first primary node, each resource type included in the node and a total quantity of resources corresponding to each resource type. The first primary node correspondingly stores an identifier of the node, each resource type included in the node, and the total quantity of resources corresponding to each resource type in the correspondence among an identifier, a resource type, and a total quantity of resources.

In the first implementation, the first primary node may receive a query response message sent by each node in the first cluster, to obtain, based on the query response message of each node, each resource type included in each node and a quantity of idle resources and a total quantity of resources corresponding to each resource type.

In a second implementation, the first primary node may store a correspondence among an identifier, a resource type, a quantity of idle resources, and a total quantity of resources. The correspondence is used to store an identifier of a node in the first cluster, a resource type currently included in the node, and a quantity of idle resources and a total quantity of resources corresponding to the resource type. The first primary node may obtain, from the correspondence, each resource type in each node included in the first cluster and a quantity of idle resources and a total quantity of resources corresponding to each resource type.

The correspondence, stored on the first primary node, among an identifier, a resource type, a quantity of idle resources, and a total quantity of resources may be created during creation of the first cluster. During creation of the first cluster, the first primary node may query each resource type included in the node in the first cluster and a quantity of idle resources and a total quantity of resources corresponding to each resource type; or the node in the first cluster sends, to the first primary node, each resource type included in the node and a quantity of idle resources and a total quantity of resources corresponding to each resource type. When obtaining each resource type included in the node and the quantity of idle resources and the total quantity of resources corresponding to each resource type, the first primary node may correspondingly store an identifier of the node, each resource type included in the node, and the quantity of idle resources and the total quantity of resources corresponding to each resource type in the correspondence among an identifier, a resource type, a quantity of idle resources, and a total quantity of resources.

After establishing the correspondence among an identifier, a resource type, a quantity of idle resources, and a total quantity of resources, the first primary node may update the correspondence among an identifier, a resource type, a quantity of idle resources, and a total quantity of resources in the following several cases. The several cases are separately described as follows:

In a first case, when a node is added to the first cluster, the first primary node may query a quantity of idle resources and a total quantity of resources corresponding to each resource type included in the node, or the node sends, to the first primary node, a quantity of idle resources and a total quantity of resources corresponding to each resource type included in the node. The first primary node correspondingly stores an identifier of the node, each resource type included in the node, and the quantity of idle resources and the total quantity of resources corresponding to each resource type in the correspondence among an identifier, a resource type, a quantity of idle resources, and a total quantity of resources.

In a second case, the first primary node may periodically query a quantity of idle resources corresponding to each resource type currently included in the node in the first cluster, and separately update a quantity of idle resources corresponding to each resource type corresponding to an identifier of the node in the correspondence among an identifier, a resource type, a quantity of idle resources, and a total quantity of resources to the quantity of idle resources corresponding to each resource type currently included in the node.

In a third case, when an idle resource corresponding to a resource type included in a node in the first cluster changes, the node sends the resource type and a quantity of current idle resources to the first primary node. The first primary node receives the resource type and the quantity of current idle resources, and updates a quantity that is of idle resources corresponding to the resource type and that is corresponding to an identifier of the node in the correspondence among an identifier, a resource type, a quantity of idle resources, and a total quantity of resources to the quantity of current idle resources.

Step 102: The first primary node determines a status of each node based on the quantity of idle resources and the total quantity of resources corresponding to each resource type included in each node.

The status of the node may be a busy state or an idle state. In this step, resource usage corresponding to each resource type in each node is obtained based on a quantity of idle resources and a total quantity of resources corresponding to each resource type included in the node; and when maximum resource usage in the resource usage corresponding to each resource type is greater than or equal to a preset usage threshold, it is determined that the node is in the busy state; or when the maximum resource usage in the resource usage corresponding to each resource type is less than the preset usage threshold, it is determined that the node is in the idle state.

Optionally, in this step, based on the quantity of idle resources and the total quantity of resources corresponding to each resource type included in the node, the resource usage corresponding to each resource type in the node may be obtained by using the following first formula, and the status of the node is determined by using the following second formula.

The first formula is:

$$\{ \begin{matrix}{P}_{i} = \frac{U s {e}_{i}}{T o t a {l}_{i}} \times 100 \% \\ U s {e}_{i} = T o t a {l}_{i} - I d l {e}_{i}\end{matrix} .$$

In the first formula, Pᵢ represents resource usage corresponding to an i^{th} resource type, Idleᵢ represents a quantity of idle resources corresponding to the i^{th} resource type, and Totalᵢ represents a total quantity of resources corresponding to the i^{th} resource type.

The second formula is:

$$State ( Node ) = max ( {P}_{i} ) = \{ \begin{matrix}\geq M , State ( Node ) is a busy state \\ < M , State ( Node ) is an idle state\end{matrix} .$$

In the second formula, State(Node) represents the status of the node, M represents the preset usage threshold, and max (Pᵢ) represents the maximum resource usage in the resource usage corresponding to each resource type.

The second formula indicates that, when max (Pᵢ) is greater than or equal to M, State(Node) is equal to the busy state; or when max (Pᵢ) is less than M, State(Node) is equal to the idle state.

Each node in the cluster may alternatively determine a status of the node by using the first formula and the second formula, and send the status of the node to the first primary node.

Step 103: The first primary node determines a status of the first cluster based on the status of each node included in the first cluster.

The status of the first cluster may be the busy state or the idle state. In this step, the first primary node obtains a quantity of nodes in the busy state and a total quantity of nodes in the first cluster; obtains a ratio of the nodes in the busy state and a quantity of nodes in the idle state based on the quantity of nodes in the busy state and the total quantity of nodes; and when the ratio is greater than or equal to a preset ratio threshold and the quantity of nodes in the idle state is less than a preset quantity threshold, determines that the status of the first cluster is the busy state; or when the ratio is greater than or equal to the preset ratio threshold and the quantity of nodes in the idle state is greater than or equal to the preset quantity threshold, or when the ratio is less than the preset ratio threshold, determines that the status of the first cluster is the idle state.

Optionally, the first primary node stores the correspondence among an identifier, a resource type, a quantity of idle resources, and a total quantity of resources, or stores the correspondence among an identifier, a resource type, and a total quantity of resources. The first primary node may count a quantity of node identifiers included in either of the foregoing two correspondences stored on the first primary node, to obtain the total quantity of nodes in the first cluster.

Optionally, in this step, the ratio of the nodes in the busy state and the quantity of nodes in the idle state are obtained and the status of the first cluster is determined based on the quantity of nodes in the busy state and the total quantity of nodes by using the following third formula.

The third formula is:

$$State ( cluster ) = q = \frac{x}{y} \times 100 \% = \{ \begin{matrix}\geq W and y - x < u , S t ate ( cluster ) is a busy state \\ \geq W and y - x \geq u , S t ate ( cluster ) is an idle state \\ < W , State ( cluster ) is an idle state\end{matrix} .$$

In the third formula, State(cluster) represents the status of the first cluster, q represents the ratio of the nodes in the busy state, X represents the quantity of nodes in the busy state, Y represents the total quantity of nodes in the first cluster, W represents the preset ratio threshold, and u represents the preset quantity threshold.

The third formula indicates that, when q is greater than or equal to W and y−x is less than u, State(cluster) is equal to the busy state; when q is greater than or equal to W and y−x is greater than or equal to u, State(cluster) is equal to the idle state; and when q is less than W, State(cluster) is equal to the idle state.

Step 104: The first primary node broadcasts cluster information of the first cluster to each second cluster in a cluster resource pool, where the cluster information includes an identifier, a status, and idle resource information that are of the first cluster, the idle resource information includes at least a resource type of each type of idle resource included in the node in the first cluster and a quantity of idle resources, and the cluster resource pool includes an identifier of at least one second cluster other than the first cluster.

Optionally, the first primary node stores the identifier of the first cluster, and the identifier of the first cluster in the cluster information may be an identifier of the first cluster that is stored in and obtained by the primary node.

Optionally, the first primary node may further store a cluster type of the first cluster, and the cluster information may further include information such as the cluster type and/or the quantity of nodes in the idle state that are included in the first cluster.

Optionally, the first primary node includes the cluster resource pool. The cluster resource pool may be established in advance by the first primary node, or may be configured on the first primary node in advance by a skilled person.

When a plurality of clusters in the network architecture shown in FIG. 1 or FIG. 2 are located in a same local area network, the first primary node may periodically broadcast a probe message, and the probe message may include the identifier of the first cluster. Similarly, the first primary node may alternatively receive a probe message sent by a primary node in another cluster, and add, to the cluster resource pool, an identifier that is of the another cluster and that is included in the probe message.

Optionally, when the first primary node periodically broadcasts the probe message, a moment is randomly selected from a start moment of each cycle to a first moment, and the probe message is broadcast at the selected moment. A time length between the first moment and the start moment is a first preset length, and the first preset length is less than a cycle length of the cycle.

Because the first primary node randomly selects a moment from the start moment of each cycle to the first moment, and broadcasts the probe message at the selected moment, primary nodes in all clusters in the local area network can be prevented from simultaneously broadcasting probe messages, so that a conflict and a broadcast storm are avoided.

Optionally, the cycle length of the cycle may remain unchanged, or the first primary node may gradually increase the cycle length of the cycle, to reduce a quantity of probe messages to be broadcast and reduce a communication amount of messages, thereby reducing network resource occupation.

For example, after broadcasting the probe message for the first time, the first primary node increases the cycle length of the cycle every a period of time. A time length of the period of time is greater than the cycle length of the cycle.

Optionally, the time length of the period of time may be equal to z times the cycle length of the cycle, where z is a value greater than 1, and z may be an integer or a non-integer.

Optionally, a time length of a period of time in each interval may be equal, and the time length may be a second preset length, or may be a length determined by the first primary node. Alternatively, a time length of a period of time in each interval may be unequal, and the time length may be set by the first primary node.

When a plurality of clusters in the network architecture shown in FIG. 1 or FIG. 2 are in different local area networks, a user may configure the cluster resource pool on the first primary node.

Step 105: The first primary node receives cluster information of at least one second cluster other than the first cluster, and forms a cluster state information table by using cluster information of a second cluster in the idle state in the at least one second cluster.

In the network architecture shown in FIG. 1, a primary node in each cluster broadcasts, based on steps 101 to 104, cluster information of the cluster in which the primary node is located. Therefore, the first primary node in the first cluster receives the cluster information of the at least one second cluster other than the first cluster.

In this step, the first primary node may obtain cluster information of n second clusters in the idle state from the cluster information of the at least one second cluster, and form the cluster state information table by using the cluster information of the n second clusters, where n is an integer greater than 0. Alternatively, the first primary node determines, based on cluster information of each of the n second clusters by using a prediction model, a second cluster whose state is to change to the busy state, removes, from the cluster information of the n second clusters, cluster information of the second cluster that is to change to the busy state, and forms the cluster state information table by using cluster information of a remaining second cluster.

In the network architecture shown in FIG. 1 or FIG. 2, a primary node in each cluster broadcasts, randomly, periodically, or when being triggered by an event, cluster information of the cluster in which the primary node is located. Therefore, whenever receiving cluster information of each second cluster in the cluster resource pool, the first primary node may obtain the cluster state information table based on the received cluster information; or the first primary node may generate the cluster state information table every a period of time, and a time length of each interval may be equal or unequal, and the time length of the interval may be set by the first primary node or may be a preset value. The first primary node may generate the cluster state information table based on cluster information received between first time and current time, and the first time is time at which the cluster state information table is generated last time.

In this embodiment of this application, because the first primary node generates the cluster state information table, and the cluster state information table includes cluster information of a cluster whose current state is the idle state, the first primary node may first determine m second clusters based on the cluster state information table when querying a cluster, and then query the m second clusters, where states that are of the m second clusters and that are in the cluster state information table are the idle state, and quantities of idle resources corresponding to a resource type that are required by the task and included in the m second clusters are greater than a quantity of required resources required by the task. This can improve query efficiency.

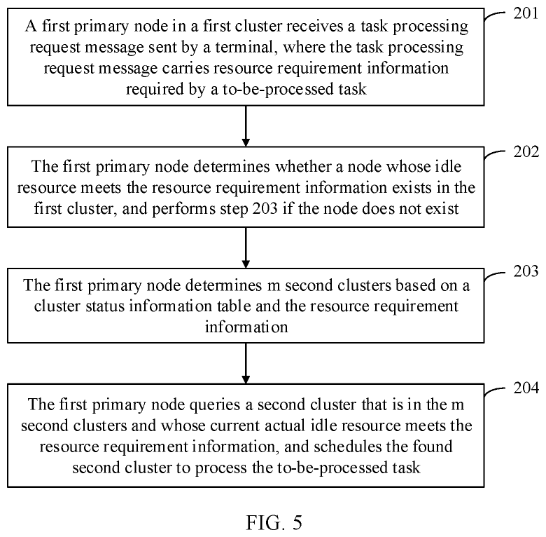

Refer to FIG. 5. An embodiment of this application provides a method for scheduling a task processing entity. The method may be applied to the network architecture shown in FIG. 1 or FIG. 2, and in the method, the task processing entity is a cluster. The method includes the following steps.

Step 201: A first primary node in a first cluster receives a task processing request message sent by a terminal, where the task processing request message carries resource requirement information required by a to-be-processed task.

The first cluster is any cluster in the network architecture, and the resource requirement information may include a resource type and a quantity of required resources.

Step 202: The first primary node determines whether a node whose idle resource meets the resource requirement information exists in the first cluster, and performs step 203 if the node does not exist.

The first primary node may obtain a quantity of idle resources corresponding to the resource type that are included in each node in the first cluster, and determine whether a node whose quantity of idle resources corresponding to the resource type is greater than the quantity of required resources exists; and determine, if the node does not exist, that a node whose idle resource meets the resource requirement information does not exist in the first cluster; or determine, if the node exists, that a node whose idle resource meets the resource requirement information exists in the first cluster.

If it is determined that there is the node whose idle resource meets the resource requirement information exists in the first cluster, the first primary node may select a node from the determined node, and send the task processing request message to the selected node, and the selected node processes the to-be-processed task.

Step 203: The first primary node determines m second clusters based on a cluster state information table and the resource requirement information, where states of the m second clusters each are an idle state, a quantity of idle resources corresponding to the resource type that are included in each of the m second clusters is greater than the quantity of required resources, and m is an integer greater than or equal to 1.

The first primary node stores the cluster state information table. The cluster state information table includes cluster information of at least one second cluster other than the first cluster, the cluster information of the second cluster includes an identifier, a status, and idle resource information that are of the second cluster, and the idle resource information includes information such as a quantity of idle resources and a resource type that are of each type of idle resource included in a node in the second cluster. The first primary node may obtain and store the cluster state information table by using the method shown in FIG. 4, and details are not described herein again.

In this step, the first primary node determines a second cluster in the idle state from the cluster state information table. For each determined second cluster, if a quantity of idle resources corresponding to the resource type that are included in a node in the second cluster is greater than a quantity of required resources corresponding to the resource type, the first primary node determines that the quantity of idle resources corresponding to the resource type that are included in the second cluster is greater than the quantity of required resources, and selects m second clusters from second clusters whose quantities of idle resources corresponding to the resource type are greater than the quantity of required resources.

Step 204: The first primary node queries a second cluster that is in the m second clusters and whose current actual idle resource meets the resource requirement information, and schedules the found second cluster to process the to-be-processed task.

In this step, the first primary node reads an identifier of each second cluster from cluster information of each of the m second clusters, and concurrently sends query request messages to the second clusters based on the identifiers of the second clusters. The query request message carries the resource requirement information required by the to-be-processed task.

The resource requirement information includes the resource type and the quantity of required resources. A second primary node in each of the m second clusters receives the query request message, and queries whether a node whose quantity of included idle resources corresponding to the resource type is greater than the quantity of required resources exists in the second cluster; and sends a query result to the first primary node if it is found that the node whose quantity of included idle resources corresponding to the resource type is greater than the quantity of required resources exists, where the query result is that an idle resource included in the second cluster meets the resource requirement information; or sends a query result to the first primary node if it is found that the node whose quantity of included idle resources corresponding to the resource type is greater than the quantity of required resources does not exist, where the query result is that the idle resource included in the second cluster does not meet the resource requirement information.

The first primary node receives a query result sent by each second cluster, selects a second cluster that sends a query result that an idle resource meets the resource requirement information, and schedules the selected second cluster to process the to-be-processed task.

Optionally, the first primary node may select a query result that is received for the first time and that indicates that an idle resource meets the resource requirement information, determine a second cluster that sends the selected query result, and schedule the determined second cluster to process the to-be-processed task.

In this embodiment of this application, because the first primary node generates the cluster state information table, and the cluster state information table includes cluster information of the second cluster in the idle state, when querying a cluster for the to-be-processed task, the first primary node may first determine, based on the cluster state information table, a second cluster in the idle state that includes an idle resource meeting the resource requirement information required by the task, and then query the determined cluster. In this way, a query range is narrowed down. Because a probability that each second cluster includes a current actual idle resource meeting the resource requirement information is large, a second cluster whose current actual idle resource meets the resource requirement information can be quickly found during query of the m second clusters. This can improve query efficiency and scheduling efficiency.

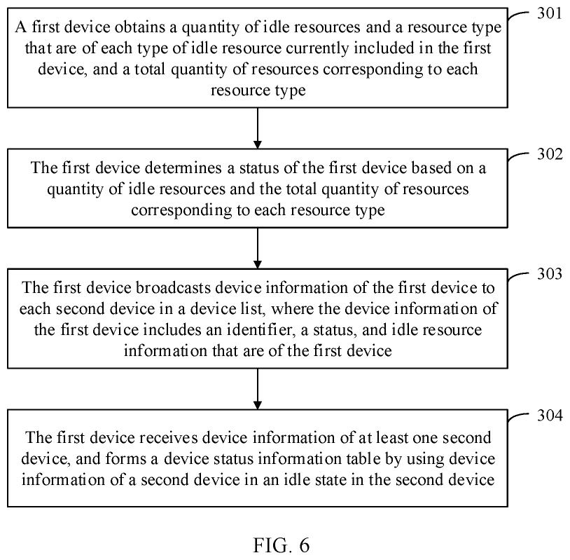

In the network architecture shown in FIG. 1 or FIG. 3, a device in the network architecture obtains and stores a device status information table, so that it can be ensured that only when an idle resource included in the device cannot meet an idle resource of a resource type required for processing the task, can the device efficiently query and schedule, based on the device status information table, another device whose idle resource meets a requirement for processing the task. Refer to FIG. 6. This application provides a method for obtaining a device status information table. The method may be applied to the network architecture shown in FIG. 1 or FIG. 3. The method includes the following steps.

Step 301: A first device obtains a quantity of idle resources and a resource type that are of each type of idle resource currently included in the first device, and a total quantity of resources corresponding to each resource type, where the first device is any device in the network architecture.

Optionally, the resource type included in the first device may be a CPU, a GPU, a memory, and/or the like. The quantity of each type of idle resource currently included in the first device and the total quantity of resources may be a quantity of idle CPUs currently included in the first device and a total quantity of CPUs, a quantity of idle GPUs and a total quantity of GPUs, a size of an idle memory and a total memory size, and/or the like.

The first device may obtain device information of the first device periodically, randomly, or when being triggered by an event. When determining to obtain the device information of the first device, the first device starts to perform this step.

Step 302: The first device determines a status of the first device based on a quantity of idle resources and the total quantity of resources corresponding to each resource type.

The status of the first device may be a busy state or an idle state. In this step, resource usage corresponding to each resource type is obtained based on the quantity of idle resources and the total quantity of resources corresponding to each resource type; and when maximum resource usage in the resource usage corresponding to each resource type is greater than or equal to a preset usage threshold, it is determined that the status of the first device is the busy state; or when the maximum resource usage in the resource usage corresponding to each resource type is less than the preset usage threshold, it is determined that the status of the first device is the idle state.

Step 303: The first device broadcasts device information of the first device to each second device in a device list, where the device information of the first device includes an identifier, a status, and idle resource information that are of the first device, the idle resource information includes at least a resource type of each type of idle resource in the first device and a quantity of idle resources, and the device list includes an identifier of at least one second device other than the first device.

Optionally, the first device includes the device list. The device list may be created by the first device before this step is performed, or may be configured on the first device in advance by a skilled person.

When a plurality of devices in the network architecture shown in FIG. 3 are located in a same local area network, the first device may periodically broadcast a probe message, and the probe message may include the identifier of the first device. Similarly, the first device may alternatively receive a probe message sent by another device, and add an identifier of the another device that is included in the probe message to the device list.

Optionally, the first device may periodically broadcast the probe message, randomly select a moment from a start moment of each cycle to a first moment, and broadcast the probe message at the selected moment. A time length between the first moment and the start moment is a first preset length, and the first preset length is less than a cycle length of the cycle.

Because the first device randomly selects a moment from the start moment of each cycle to the first moment, and broadcasts the probe message at the selected moment, all devices in the local area network can be prevented from simultaneously broadcasting probe messages, so that a conflict and a broadcast storm are avoided.

Optionally, the cycle length of the cycle may remain unchanged, or the first device may gradually increase the cycle length of the cycle, to reduce a quantity of probe messages to be broadcast and reduce a quantity of messages, thereby reducing network resource occupation.

For example, after broadcasting the probe message for the first time, the first device increases the cycle length of the cycle every a period of time. A time length of the period of time in each interval is greater than the cycle length of the cycle.

Optionally, the time length of the interval may be equal to z times the cycle length of the cycle, where z is a value greater than 1, and z may be an integer or a non-integer.

Optionally, a time length of the interval may be equal, and the time length of the interval may be a second preset length, or may be a length determined by the first device. Alternatively, the time length of the interval may be unequal, and the time length of the interval may be set by the first device.

When a plurality of devices in the network architecture shown in FIG. 1 or FIG. 3 are in different local area networks, a user may configure the device list on the first device.

Step 304: The first device receives device information of the at least one second device, and forms a device status information table by using device information of a second device in the idle state in the at least one second device.

In the network architecture shown in FIG. 3, each device broadcasts respective device information based on steps 301 to 303. Therefore, the first device receives the device information of the at least one second device other than the first device.

In this step, the first device may obtain, from the device information of the at least one second device, device information of n second devices in the idle state, where n is an integer greater than 0, and form the device state information table by using the device information of the n second devices. Alternatively, the first device determines, based on the device information of the n second devices by using a prediction model, a second device whose state is to change to the busy state, removes, from the device information of the n second devices, device information of the second device that is to change to the busy state, and forms the device status information table based on device information of a remaining second device.

Each device in the network architecture shown in FIG. 1 broadcasts respective device information randomly, periodically, or when being triggered by an event. Therefore, whenever receiving device information of each second device in the device list, the first device may obtain the device status information table based on the received device information; or the first device may generate the device status information table every a period of time, and a time length of the interval may be equal or unequal. The time length of the interval may be set by the first device or may be a preset value. The first device generates the device status information table based on device information received between first time and current time. The first time is time at which the device status information table is generated last time.

In this embodiment of this application, because the first device generates the device status information table, and the device status information table includes device information of a second device whose current state is the idle state, when querying a device for the to-be-processed task, the first device may first determine, based on the device status information table, a second device in the idle state that includes an idle resource belonging to a resource type required by the task and meeting the quantity of required resources required by the task, and then query and schedule the determined second device. This can improve query efficiency and device scheduling efficiency.

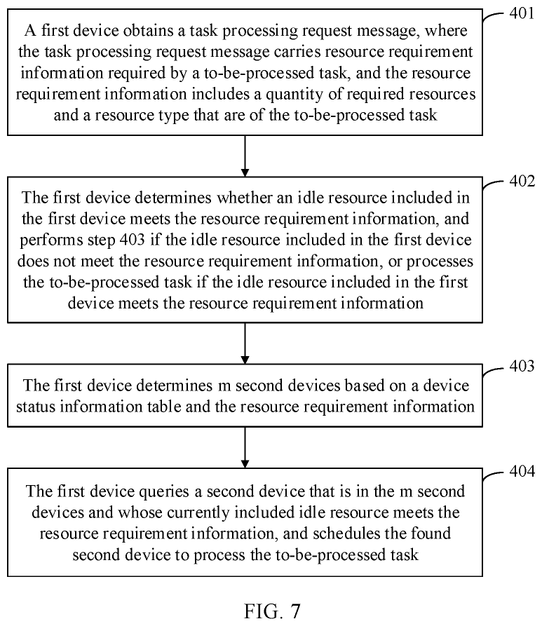

Refer to FIG. 7. An embodiment of this application provides a method for scheduling a task processing entity. The method may be applied to the network architecture shown in FIG. 1 or FIG. 3, and in the method, the task processing entity is a device. The method includes the following steps.

Step 401: A first device obtains a task processing request message, where the task processing request message carries resource requirement information required by a to-be-processed task, and the resource requirement information includes a quantity of required resources and a resource type that are of the to-be-processed task.

The first device may be an edge device or an end-side device connected to a terminal, and the first device may receive a task processing request message sent by the terminal connected to the first device.

Step 402: The first device determines whether an idle resource included in the first device meets the resource requirement information, and performs step 403 if the idle resource included in the first device does not meet the resource requirement information, or processes the to-be-processed task if the idle resource included in the first device meets the resource requirement information.

Step 403: The first device determines m second devices based on a device status information table and the resource requirement information, where states of the m second devices each are in an idle state, a second device including an idle resource that is corresponding to the resource type and that meets a quantity of required resources corresponding to the resource type exists in the m second devices, and m is an integer greater than or equal to 1.

The first device stores the device status information table. The device status information table includes device information of a second device other than the first device, and the device information of the second device includes information such as an identifier of the second device, a status of the second device, and a quantity of idle resources corresponding to each resource type included in the second device. The first device may obtain and store the device status information table by using the method shown in FIG. 6, and details are not described herein again.

In this step, the first device determines the second device in the idle state from the device status information table, determines, based on device information of each determined second device from the determined second devices, second devices whose quantities of included idle resources corresponding to the resource type are greater than the quantity of required resources, and selects m second devices from the second devices whose quantities of included idle resources corresponding to the resource type are greater than the quantity of required resources.

Step 404: The first device queries a second device that is in the m second devices and whose currently included idle resource meets the resource requirement information, and schedules the found second device to process the to-be-processed task.

In this step, the first device reads an identifier of each second device from device information of the m second devices, and concurrently sends query request messages to the second devices based on the identifiers of the second devices. The query request message carries the resource requirement information required by the to-be-processed task.

Any second device in the m second devices queries, by using the query request message, whether a quantity of currently actually included idle resources corresponding to the resource type is greater than the quantity of required resources; and sends a query result to the first device if it is found that the quantity of currently actually included idle resources corresponding to the resource type is greater than the quantity of required resources, where the query result is that an idle resource meets the resource requirement information; or sends a query result if it is found that the quantity of currently actually included idle resources corresponding to the resource type is not greater than the quantity of required resources, where the query result is that an idle resource does not meet the resource requirement information.

The first device receives a query result sent by each second device, selects a second device that sends a query result that the idle resource meets the resource requirement information, and schedules the selected second device to process the to-be-processed task.

Optionally, the first device may select a query result that is received for the first time and that indicates that an idle resource meets the resource requirement information, determine a second device that sends the selected query result, and schedule the determined second device to process the to-be-processed task.

In this embodiment of this application, because the first device generates the device status information table, and the device status information table includes device information of a second device whose current state is the idle state, when querying a second device for the to-be-processed task, the first device may first determine, based on the device status information table, a second device in the idle state that includes an idle resource meeting the resource requirement information required by the task, and then query the determined device. In this way, a query range is narrowed down. Because a probability that an idle resource currently actually included in each second device meets the resource requirement information is large, a second device whose current actual idle resource meets the resource requirement information can be quickly founded during query of the m second devices. This can improve query efficiency and scheduling efficiency.

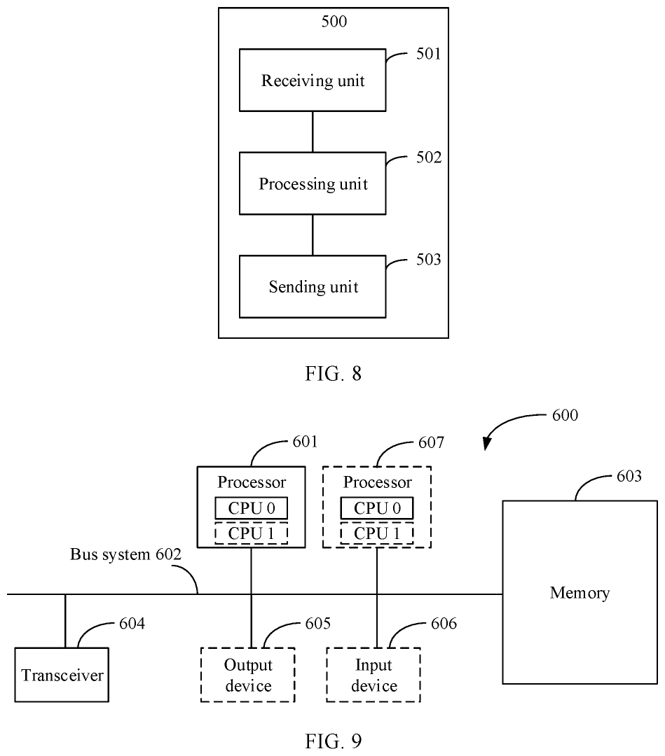

Refer to FIG. 8. An embodiment of this application provides an apparatus 500 for scheduling a task processing entity. The apparatus 500 may be deployed on the first task processing entity in the foregoing embodiment, and may be deployed on the foregoing first primary node or the foregoing first device during implementation. The apparatus 500 includes:

a receiving unit 501, configured to receive a task processing request message, where the task processing request message carries resource requirement information required by a to-be-processed task, the resource requirement information includes at least a quantity of required resources and a resource type that are required for processing the to-be-processed task, and the first task processing entity is a cluster or a device; and a processing unit 502, configured to: when an idle resource included in the apparatus 500 does not meet the resource requirement information, determine m second task processing entities based on an entity status information table and the resource requirement information, where the entity status information table includes entity information sent by at least one second task processing entity and received by the first task processing entity, the entity information sent by the second task processing entity includes an identifier, a status, and idle resource information that are of the second task processing entity, the idle resource information includes at least a resource type of an idle resource in the second task processing entity and a quantity of idle resources, a status that is of each of the m second task processing entities and that is recorded in the entity status information table is an idle state, a quantity of idle resources corresponding to the resource type that are in each second task processing entity is greater than the quantity of required resources, and m is an integer greater than or equal to 1.

The processing unit 502 is further configured to: query, from the m second task processing entities, a second task processing entity that currently includes an idle resource meeting the resource requirement information, and schedule the found second task processing entity to process the to-be-processed task.

Optionally, the apparatus 500 further includes a sending unit 503.

The processing unit 502 is further configured to obtain entity information of the apparatus.

The sending unit 503 is configured to send the entity information to each task processing entity in an entity list, where the entity list includes an identifier of at least one task processing entity other than the apparatus 500.

Optionally, the processing unit 502 is configured to:

obtain a quantity of idle resources and a total quantity of resources corresponding to each resource type included in the apparatus, and determine a status of the apparatus based on the quantity of idle resources and the total quantity of resources corresponding to each resource type.

Optionally, the apparatus 500 is a cluster, and the processing unit 502 is configured to:

obtain each resource type included in each node in the cluster and a quantity of idle resources and a total quantity of resources corresponding to each resource type;

determine a status of each node based on the quantity of idle resources and the total quantity of resources corresponding to each resource type included in each node; and

determine a status of the cluster based on the status of each node.

Optionally, the processing unit 502 is configured to:

obtain, based on each resource type included in the node and the quantity of idle resources and the total quantity of resources corresponding to each resource type, resource usage corresponding to each resource type in the node; and

when maximum resource usage in the resource usage corresponding to each resource type is greater than or equal to a preset usage threshold, determine that the node is in a busy state; or when the maximum resource usage is less than the preset usage threshold, determine that the node is in the idle state.

Optionally, the sending unit 503 is configured to send a query request message to each of the m second task processing entities, where the query request message carries the resource requirement information, and the query request message is used by the second task processing entity to query whether an idle resource included in the second task processing entity meets the resource requirement information.

The receiving unit 501 is further configured to receive a query result sent by each second task processing entity.

The processing unit 502 is further configured to: select a query result that is received for the first time and that indicates that an idle resource meets the resource requirement information; and schedule a second task processing entity that sends the selected query result to process the to-be-processed task.

Optionally, the processing unit 502 is configured to:

obtain a quantity of nodes in the busy state and a total quantity of nodes in the cluster;

obtain a ratio of the nodes in the busy state and a quantity of nodes in the idle state based on the quantity of nodes in the busy state and the total quantity of nodes; and

when the ratio is greater than or equal to a preset ratio threshold and the quantity of nodes in the idle state is less than a preset quantity threshold, determine that the cluster is in the busy state; or when the ratio is greater than or equal to the preset ratio threshold and the quantity of nodes in the idle state is greater than or equal to the preset quantity threshold, or when the ratio is less than the preset ratio threshold, determine that the cluster is in the idle state.

Optionally, the receiving unit 501 is further configured to receive entity information of at least one second task processing entity.

The processing unit 502 is further configured to: obtain entity information of n second task processing entities in the idle state from the entity information of the at least one second task processing entity, where n is an integer greater than or equal to 1; determine, based on entity information of each of the n second task processing entities by using a prediction model, a second task processing entity whose state is to change to the busy state; and remove, from the entity information of the n second task processing entities, entity information of the second task processing entity that is to change to the busy state, and form the entity status information table by using entity information of a remaining second task processing entity.

In this embodiment of this application, because the processing unit generates the entity status information table, and the entity status information table includes entity information of a second task processing entity whose current state is the idle state, when querying a second task processing entity for the to-be-processed task, the processing unit may first determine, based on the entity status information table, a second task processing entity in the idle state that includes an idle resource meeting the resource requirement information required by the task. This can improve query efficiency and scheduling efficiency.

FIG. 9 is a schematic diagram of an apparatus 600 for scheduling a task processing entity according to an embodiment of this application. The apparatus 600 includes at least one processor 601, a system bus 602, a memory 603, and at least one transceiver 604.

The apparatus 600 is an apparatus of a hardware structure, and may be configured to implement functional modules in the apparatus in FIG. 8. For example, a skilled person may figure out that the processing unit 502 in the apparatus 500 shown in FIG. 8 may be implemented by the at least one processor 601 by invoking code in the memory 603, and the receiving unit 501 and the sending unit 503 in the apparatus 500 shown in FIG. 8 may be implemented by the transceiver 604.

Optionally, the processor 601 may be a general-purpose central processing unit (central processing unit, CPU), a microprocessor, an application-specific integrated circuit (application-specific integrated circuit, ASIC), or one or more integrated circuits configured to control program execution in the solutions of this application.

The bus system 602 may include a path for transmitting information between the foregoing components.

The transceiver 604 is configured to communicate with another device or a communications network.

The memory 603 may be a read-only memory (read-only memory, ROM) or another type of static storage device capable of storing static information and instructions, or a random access memory (random access memory, RAM) or another type of dynamic storage device capable of storing information and instructions, or may be an electrically erasable programmable read-only memory (electrically erasable programmable read-only memory, EEPROM), a compact disc read-only memory (compact disc read-only memory, CD-ROM) or another compact disc storage, an optical disc storage (including a compressed optical disc, a laser disc, an optical disc, a digital versatile disc, a Blu-ray disc, and the like), a magnetic disk storage medium or another magnetic storage device, or any other medium capable of including or storing expected program code in a form of an instruction or a data structure and capable of being accessed by a computer. However, the memory is not limited thereto. The memory may exist independently, and is connected to the processor through the bus. The memory may alternatively be integrated with the processor.

The memory 603 is configured to store application program code for executing the solutions in this application, and the processor 601 controls the execution. The processor 601 is configured to execute the application program code stored in the memory 603, to implement functions in the method in this patent.

During specific implementation, in an embodiment, the processor 601 may include one or more CPUs, for example, a CPU 0 and a CPU 1 in FIG. 9.

During specific implementation, in an embodiment, the apparatus 600 may include a plurality of processors, for example, the processor 601 and a processor 607 in FIG. 9. Each of the processors may be a single-core (single-CPU) processor, or may be a multi-core (multi-CPU) processor. The processor herein may be one or more devices, circuits, and/or processing cores configured to process data (for example, computer program instructions).

During specific implementation, in an embodiment, the apparatus 600 may further include an output device 605 and an input device 606. The output device 605 communicates with the processor 601, and may display information in a plurality of manners. For example, the output device 605 may be a liquid crystal display (liquid crystal display, LCD), or the like. The input device 606 communicates with the processor 601, and may receive input of a user in a plurality of manners. For example, the input device 606 may be a touchscreen device or a sensor device.

A person of ordinary skills in the art may understand that all or some of the steps of the embodiments may be implemented by hardware or a program instructing related hardware. The program may be stored in a computer-readable storage medium. The storage medium may be a read-only memory, a magnetic disk, an optical disc, or the like.

The foregoing descriptions are only optional embodiments of this application, but are not intended to limit this application. Any modification, equivalent replacement, improvement, or the like made without departing from the spirit and principle of this application shall fall within the protection scope of this application.

1. A method for scheduling a task processing entity, wherein the method comprises:
receiving, by a first task processing entity, a task processing request message, wherein the task processing request message carries resource requirement information associated with a to-be-processed task, the resource requirement information comprises at least a quantity of required resources and a resource type that are associated with the to-be-processed task, and the first task processing entity is a cluster or a device;
in response to determining that a first idle resource comprised in the first task processing entity does not meet the resource requirement information, determining, by the first task processing entity, m second task processing entities based on an entity status information table and the resource requirement information, wherein the entity status information table comprises entity information sent by a second task processing entity and received by the first task processing entity, the entity information comprises an identifier, a status, and idle resource information that are associated with the second task processing entity, the idle resource information comprises at least a resource type of a second idle resource in the second task processing entity and a quantity of the second idle resource, wherein a status that is of each of the m second task processing entities and that is recorded in the entity status information table is an idle state, a quantity of idle resources corresponding to the resource type that are in each second task processing entity is greater than the quantity of required resources, and m is an integer greater than or equal to 1;
identifying, by the first task processing entity from the m second task processing entities, a particular second task processing entity that currently comprises an idle resource meeting the resource requirement information; and
scheduling the particular second task processing entity to process the to-be-processed task.

2. The method according to claim 1, before the determining, by the first task processing entity, m second task processing entities based on an entity status information table and the resource requirement information, further comprising:
obtaining, by the first task processing entity, first entity information of the first task processing entity; and
sending the first entity information to each task processing entity in an entity list, wherein the entity list comprises an identifier of at least one task processing entity other than the first task processing entity.

3. The method according to claim 2, wherein the obtaining, by the first task processing entity, first entity information of the first task processing entity comprises:
obtaining, by the first task processing entity, each resource type comprised in the first task processing entity, a quantity of idle resources corresponding to each resource type, and a total quantity of resources; and
determining, by the first task processing entity, a status of the first task processing entity based on the quantity of idle resources corresponding to each resource type and the total quantity of resources.

4. The method according to claim 3, wherein the first task processing entity is a cluster, and the obtaining, by the first task processing entity, each resource type comprised in the first task processing entity, a quantity of idle resources corresponding to each resource type, and a total quantity of resources comprises:
obtaining each resource type comprised in each node in the cluster, a quantity of idle resources corresponding to each resource type, and a total quantity of resources; and
wherein the determining, by the first task processing entity, a status of the first task processing entity based on the quantity of idle resources corresponding to each resource type and the total quantity of resources comprises:
determining a status of each node based on the quantity of idle resources and the total quantity of resources comprised in each node; and
determining a status of the cluster based on the status of each node.

5. The method according to claim 4, wherein the determining a status of each node based on the quantity of idle resources and the total quantity of resources comprised in each node comprises:
obtaining, based on the quantity of idle resources and the total quantity of resources comprised in a node, resource usage corresponding to each resource type in the node; and
in response to determining that maximum resource usage in the resource usage corresponding to each resource type is greater than or equal to a preset usage threshold, determining that the node is in a busy state; or
in response to determining that the maximum resource usage is less than the preset usage threshold, determining that the node is in the idle state.

6. The method according to claim 4, wherein the determining a status of the cluster based on the status of each node comprises:
obtaining a quantity of nodes in a busy state and a total quantity of nodes in the cluster;
obtaining a ratio of the quantity of nodes in the busy state and a quantity of nodes in the idle state based on the total quantity of nodes; and
in response to determining that the ratio is greater than or equal to a preset ratio threshold and that the quantity of nodes in the idle state is less than a preset quantity threshold, determining that the cluster is in the busy state; or
in response to determining that (i) the ratio is greater than or equal to the preset ratio threshold and the quantity of nodes in the idle state is greater than or equal to the preset quantity threshold or (ii) the ratio is less than the preset ratio threshold, determining that the cluster is in the idle state.

7. The method according to claim 1, wherein the identifying, by the first task processing entity from the m second task processing entities, a second task processing entity that currently comprises an idle resource meeting the resource requirement information comprises:
sending, by the first task processing entity, a query request message to each of the m second task processing entities, wherein the query request message carries the resource requirement information, and the query request message is used by a corresponding second task processing entity to query whether an idle resource comprised in the corresponding second task processing entity meets the resource requirement information;
receiving, by the first task processing entity, a query result sent by each second task processing entity;
selecting, by the first task processing entity, a query result that is received for the first time and that indicates that an idle resource meets the resource requirement information; and
wherein the scheduling the particular second task processing entity to process the to-be-processed task comprises scheduling, by the first task processing entity, the particular second task processing entity that sends the selected query result to process the to-be-processed task.

8. The method according to claim 1, before the determining, by the first task processing entity, m second task processing entities based on an entity status information table and the resource requirement information, further comprising:
receiving, by the first task processing entity, entity information of at least one second task processing entity;
obtaining, by the first task processing entity, entity information of n second task processing entities in the idle state from the entity information of the at least one second task processing entity, wherein n is an integer greater than or equal to 1;
determining, by the first task processing entity based on entity information of each of the n second task processing entities by using a prediction model, a second task processing entity whose state is to change to a busy state;
removing, by the first task processing entity from the entity information of the n second task processing entities, entity information of the second task processing entity that is to change to the busy state; and
forming the entity status information table by using entity information of a remaining second task processing entity.

9. An apparatus for scheduling a task processing entity, wherein the apparatus is a first task processing entity, wherein the apparatus comprises:
at least one processor; and
one or more memories coupled to the at least one processor and storing
executable program instructions that, when executed by the at least one processor, causes the at least one processor to:
receive, by a first task processing entity, a task processing request message, wherein the task processing request message carries resource requirement information associated with a to-be-processed task, the resource requirement information comprises at least a quantity of required resources and a resource type that are associated with the to-be-processed task, and the first task processing entity is a cluster or a device;
in response to determining that a first idle resource comprised in the first task processing entity does not meet the resource requirement information, determine, by the first task processing entity, m second task processing entities based on an entity status information table and the resource requirement information, wherein the entity status information table comprises entity information sent by a second task processing entity and received by the first task processing entity, the entity information comprises an identifier, a status, and idle resource information that are associated with the second task processing entity, the idle resource information comprises at least a resource type of a second idle resource in the second task processing entity and a quantity of the second idle resource, wherein a status that is of each of the m second task processing entities and that is recorded in the entity status information table is an idle state, a quantity of idle resources corresponding to the resource type that are in each second task processing entity is greater than the quantity of required resources, and m is an integer greater than or equal to 1;
identify, by the first task processing entity from the m second task processing entities, a particular second task processing entity that currently comprises an idle resource meeting the resource requirement information; and
schedule the particular second task processing entity to process the to-be-processed task.

10. The apparatus according to claim 9, wherein before determining the m second task processing entities, the executable program instructions further cause the at least one processor to:
obtain first entity information of the first task processing entity; and
send the first entity information to each task processing entity in an entity list, wherein the entity list comprises an identifier of at least one task processing entity other than the first task processing entity.

11. The apparatus according to claim 10, wherein obtaining the first entity information of the first task processing entity comprises:
obtaining each resource type comprised in the first task processing entity, a quantity of idle resources corresponding to each resource type, and a total quantity of resources; and
determining a status of the first task processing entity based on the quantity of idle resources corresponding to each resource type and the total quantity of resources.

12. The apparatus according to claim 11, wherein the first task processing entity is a cluster, and wherein obtaining each resource type comprises:
obtaining each resource type comprised in each node in the cluster, a quantity of idle resources corresponding to each resource type, and a total quantity of resources; and
wherein the determining a status of the first task processing entity based on the quantity of idle resources corresponding to each resource type and the total quantity of resources comprises:
determining a status of each node based on the quantity of idle resources and the total quantity of resources comprised in each node; and
determining a status of the cluster based on the status of each node.

13. The apparatus according to claim 12, wherein determining the status of each node comprises:
obtaining, based on the quantity of idle resources and the total quantity of resources comprised in a node, resource usage corresponding to each resource type in the node; and
in response to determining that maximum resource usage in the resource usage corresponding to each resource type is greater than or equal to a preset usage threshold, determining that the node is in a busy state; or
in response to determining that the maximum resource usage is less than the preset usage threshold, determining that the node is in the idle state.

14. The apparatus according to claim 12, wherein determining the status of the cluster based on the status of each node comprises:
obtaining a quantity of nodes in a busy state and a total quantity of nodes in the cluster;
obtaining a ratio of the quantity of nodes in the busy state and a quantity of nodes in the idle state based on the total quantity of nodes; and
in response to determining that the ratio is greater than or equal to a preset ratio threshold and that the quantity of nodes in the idle state is less than a preset quantity threshold, determining that the cluster is in the busy state; or
in response to determining that (i) the ratio is greater than or equal to the preset ratio threshold and the quantity of nodes in the idle state is greater than or equal to the preset quantity threshold or (ii) the ratio is less than the preset ratio threshold, determining that the cluster is in the idle state.

15. The apparatus according to claim 9, wherein identifying the particular second task processing entity comprises:
sending a query request message to each of the m second task processing entities, wherein the query request message carries the resource requirement information, and the query request message is used by a corresponding second task processing entity to query whether an idle resource comprised in the corresponding second task processing entity meets the resource requirement information;
receive a query result sent by each second task processing entity;
select a query result that is received for the first time and that indicates that an idle resource meets the resource requirement information; and
schedule the particular second task processing entity that sends the selected query result to process the to-be-processed task.

16. The apparatus according to claim 9, wherein before determining the m second task processing entities, the executable program instructions further cause the at least one processor to:
receive entity information of at least one second task processing entity;
obtain entity information of n second task processing entities in the idle state from the entity information of the at least one second task processing entity, wherein n is an integer greater than or equal to 1;
determine based on entity information of each of the n second task processing entities by using a prediction model, a second task processing entity whose state is to change to a busy state;
remove from the entity information of the n second task processing entities, entity information of the second task processing entity that is to change to the busy state; and
form the entity status information table by using entity information of a remaining second task processing entity.

17. A computer-readable storage medium storing a program, wherein the program comprises instructions, and when the instructions are executed by a computer, cause the computer to perform operations comprising:
receiving, by a first task processing entity, a task processing request message, wherein the task processing request message carries resource requirement information associated with a to-be-processed task, the resource requirement information comprises at least a quantity of required resources and a resource type that are associated with the to-be-processed task, and the first task processing entity is a cluster or a device;
in response to determining that a first idle resource comprised in the first task processing entity does not meet the resource requirement information, determining, by the first task processing entity, m second task processing entities based on an entity status information table and the resource requirement information, wherein the entity status information table comprises entity information sent by a second task processing entity and received by the first task processing entity, the entity information comprises an identifier, a status, and idle resource information that are associated with the second task processing entity, the idle resource information comprises at least a resource type of a second idle resource in the second task processing entity and a quantity of the second idle resource, wherein a status that is of each of the m second task processing entities and that is recorded in the entity status information table is an idle state, a quantity of idle resources corresponding to the resource type that are in each second task processing entity is greater than the quantity of required resources, and m is an integer greater than or equal to 1;
identifying, by the first task processing entity from the m second task processing entities, a particular second task processing entity that currently comprises an idle resource meeting the resource requirement information; and
scheduling the particular second task processing entity to process the to-be-processed task.

18. The computer-readable storage medium according to claim 17,
wherein before determining the m second task processing entities, the operations further comprise:
obtaining first entity information of the first task processing entity; and
sending the first entity information to each task processing entity in an entity list, wherein the entity list comprises an identifier of at least one task processing entity other than the first task processing entity.

19. The computer-readable storage medium according to claim 18,
wherein the obtaining first entity information of the first task processing entity comprises:
obtaining each resource type comprised in the first task processing entity, a quantity of idle resources corresponding to each resource type, and a total quantity of resources; and
determining a status of the first task processing entity based on the quantity of idle resources corresponding to each resource type and the total quantity of resources.

20. The computer-readable storage medium according to claim 19,
wherein the first task processing entity is a cluster, and the obtaining each resource type comprised in the first task processing entity, a quantity of idle resources corresponding to each resource type, and a total quantity of resources comprises:
obtaining each resource type comprised in each node in the cluster, a quantity of idle resources corresponding to each resource type, and a total quantity of resources; and
wherein the determining, by the first task processing entity, a status of the first task processing entity based on the quantity of idle resources corresponding to each resource type and the total quantity of resources comprises:
determining a status of each node based on the quantity of idle resources and the total quantity of resources comprised in each node; and
determining a status of the cluster based on the status of each node.
